(19) United States
(12) Patent Application Publication
(10) Pub. No.: US 2026/0163885 A1
(43) Pub. Date: Jun. 11, 2026

(54) A METHOD, AN APPARATUS AND A SYSTEM FOR SECURING INTERACTIONS BETWEEN USERS AND COMPUTER-BASED APPLICATIONS

(71) Applicant: OneSpan North America Inc., Boston, MA (US)

(72) Inventor: Harm BRAAMS, Nieuwegein (NL)

(21) Appl. No.: 19/123,832

(22) PCT Filed: Nov. 1, 2023
(86) PCT No.: PCT/US2023/078359

§ 371 Date: Apr. 24, 2025

Related U.S. Application Data
(60) Provisional application No. 63/422,405, filed on Nov. 3, 2022.

(51) Int. Cl. H04L 9/40

(52) U.S. Cl. CPC H04L 63/10

(57) ABSTRACT

Methods, apparatus, and systems for securing the interaction of a user with a computer-based application are disclosed. A security server secures the operation by receiving from the computer-based application a request to perform a security task for the user, identifying a security operation script corresponding to the security task, sending a request to perform a security operation defined by the security operation script to a personal security device of the user, receiving a security operation result of performing the security operation script by the personal security device, determining a security task result as a function of the security operation result and returning the security task result to the computer-based application.

### FIELD OF THE INVENTION

The invention relates to a method, system and apparatus for securing the interactions between a plurality of users and a plurality of remotely accessible computer-based applications. More in particular, the invention relates to authenticating a user accessing a remotely accessible computer-based application and/or authenticating an electronic transaction submitted or approved by such a user to such a remotely accessible computer-based application.

### BACKGROUND OF THE INVENTION

Many computer-based applications are remotely accessible by one or more (human) users. For some computer-based application, a user accessing the computer-based application may comprise the user interacting with the computer-based application. For example, in some cases it may be possible for the user accessing the computer-based application to provide data to the computer-based application, or it may be possible for the user to electronically sign documents such as a digital agreement or a digital contract in the course of interacting with the computer-based application, or it may be possible for the user to provide instructions to the computer-based application to perform some particular action such as for example performing a payment or money transfer. In some cases, the computer-based application may offer the possibility to a user to remotely interact with other users and the user interacting with the computer-based application may effectively enable remote interactions of the user with such other users. Without lack of generalization, the above mentioned interactions of a user with a computer-based application may be referred to in what follows as transactions and the above mentioned computer-based applications that are adapted to have an interaction with a user may be referred to in what follows as transaction processing computer-based applications. In many cases a transaction processing computer-based application interacts with human users whereby such a user can submit to the transaction processing computer-based application a transaction together with an implicit or explicit approval of the submitted transaction or whereby a user can approve a transaction that is presented to that user by the transaction processing computer-based application. Typically, the transaction processing computer-based application completes or proceeds with the processing of the transaction when it has received the user's approval for the transaction. In what follows a transaction processing computer-based application that interacts with human users as described above may be referred to as a computer-based application or even simply as an application. The transactions processed by a computer-based application are characterized or defined by a set of data that in this description is referred to as a transaction data set or simply as the transaction data. Since the transactions in this description are processed by a computer-based application they may also be referred to in this description as electronic transactions.

In many cases such a computer-based application is remotely accessible by a user through a client access device that may be connected through a computer network to a computer system hosting the computer-based application. Many remotely accessible computer-based applications can be accessed through a web interface of the computer-based applications by means of a web browser on the user's client access device. A typical example is an internet banking web site that users can access over the internet by means of a web browser on, for example, their Personal Computer (PC) or laptop, whereby users can submit for example money transfer orders to transfer money from one of their bank accounts to some other bank account (typically held by some other user). Other examples of computer-based applications in the sense of this description include internet retail sites where users can submit orders to purchase goods or services and pay for these ordered goods or services, or investment sites where users can for example trade stocks. Yet other examples of computer-based applications in the sense of this description may comprise video-conferencing applications.

In some cases, anyone may have access to a particular computer-based application. In other cases, access to a particular computer-based application may be restricted to only some users and/or the type of interactions that a particular user is allowed to have with that particular computer-based application may be restricted.

In many cases a computer-based application may be the target of fraudsters desirous to inject into the computer-based application fraudulent transactions or to fraudulently manipulate and/or alter existing transactions. For example, in the case of an internet banking website, a fraudster might try to submit a fraudulent money transfer order for the transfer of an amount of money from the account of a legitimate user to an account belonging to or controlled by the fraudster. In other examples, a fraudster may impersonate someone else and for example sign a contract while pretending to be that someone else.

Many computer-based applications have put in place technical measures to protect the computer-based application from such fraudulent interactions. Some examples of solutions to secure the interaction of a user with a computer-based application are discussed below.

User Authentication. As a minimum barrier to such attempts of fraud, many computer-based applications implement some form of user authorization, i.e., whereby a user is restricted to submit only certain types of transactions (for example only money transfers from an account that is registered with the computer-based application as belonging to that user), in combination with user authentication, i.e., whereby a user must first login and provide some evidence of his/her identity before the computer-based application will make it possible for the user to submit any transaction.

MITMA. While user authentication goes a long way to thwart fraudulent attacks, user authentication by itself is not sufficient to thwart all types of fraudulent attacks. In some types of attacks, a legitimate user provides correct credentials to log into a computer-based application but a fraudulent party breaks into the communication between the legitimate user and the computer-based application and fraudulently alters a transaction submitted by the legitimate user or submits an additional fraudulent transaction. Such an attack may be referred to as a Man-In-The-Middle-Attack (MITMA).

Transaction signing. An existing solution that in principle provides a very high level of security works as follows. Instead of merely authenticating a user that logs into a computer-based application, the actual transaction purportedly submitted by that user is authenticated, i.e., it is ensured that a submitted transaction effectively originates from a legitimate user and is approved by that user and has not been altered since the user approved it. To authenticate a transaction, the user makes use of a separate electronic security apparatus to generate an electronic transaction over the transaction data. The electronic signature generated by the electronic security apparatus is then transferred to the computer-based application (e.g., by the user copying a string of digits representing the electronic signature from the display of the electronic security apparatus into a field of a webpage of the computer-based application), whereafter the computer-based application may forward the electronic signature to an authentication server for verification. The authentication server then verifies whether the electronic signature it has received is consistent with the transaction data that the computer-based application has. If the received electronic signature is not consistent with the transaction data that the computer-based application has, the electronic transaction may be rejected, otherwise it may be accepted.

Many user authentication or transaction signature mechanisms are known and used, such as user id and static password, dynamic or one-time passwords that may be generated by so-called strong authentication tokens, biometric authentication, authentication protocols based on PKI (Public Key Infrastructure) certificates and public-private key pairs, symmetric cryptography based strong authentication and transaction data signing tokens, . . . .

In general, many of the more secure solutions to secure the interaction of a user with a computer-based application rely on protocols whereby a cryptographic key that is linked to a particular user is used to parameterize a cryptographic algorithm that is used in the protocol in one or more steps of the protocol. Additionally, to further strengthen the security level, this cryptographic key is often stored and/or used in a client authentication device that is a different device than the client access device and that comprises an electronic security apparatus assumed to be resistant to fraudulent attempts to extract or abuse the cryptographic key.

Any technical security solution is always a trade-off between security, user convenience and cost. Because different computer-based applications tend to widely differ in terms of the kind of users they have, the type of transactions they support, and the sensitivity of these transactions, the optimal trade-off and hence the most appropriate security solution is different from one computer-based application to another. In other words, a one-size-fits-all security solution that optimally satisfies the widely varying requirements of the large number of existing computer-based applications does not exist, and as a result there exist a wide variety of security solutions that comprise many different security protocols using many different types of electronic security apparatus that are often not interoperable. I.e., it is common that an electronic security apparatus that users are supposed to use for securing their interactions with one particular computer-based application cannot be used by these same users to secure their interactions with another computer-based application.

Also, it is not uncommon that the security requirements of a given application evolve in time, e.g., because the application itself changes or because the threat landscape changes (e.g., attackers getting more sophisticated), such that the security capabilities offered by a particular electronic security apparatus after some time no longer satisfy the needs of the application.

What is needed is a solution for securing the interactions of users with remotely accessible computer-based applications that provides a high level of security while at the same time being flexible to cater for the evolving security needs of applications and to support additional applications.

### Technical Solution

A solution to the aforementioned problem is the invention described in the remainder of this description.

In one aspect of the invention, a system is provided for securing the interaction of a user with a computer-based application. In some embodiments, the system may be used with any of the methods described elsewhere in this description.

In a first set of embodiments of the system, the system comprises:
a plurality of personal security devices (200); and
a security server (120);
wherein:
the security server is adapted to:
   receive from the computer-based application a request to perform a security task for the user;
   identify among the plurality of personal security devices a personal security device associated with the user;
   identifying a security operation script corresponding to the security task;
   sending to the identified personal security device a request to perform a security operation defined by the security operation script;
the personal security devices are adapted to:
   receive from the security server a request to perform a security operation defined by a security operation script;
   obtain the security operation script defining the security operation requested by the security server;
   perform the obtained security operation script;
   return to the security server a security operation result of performing the obtained security operation script;
the security server is further adapted to:
   receive from the identified personal security device a security operation result;
   determine a security task result as a function of the security operation result;
   return the security task result to the computer-based application.

In another aspect of the invention, a computer-based method is provided for securing the interaction of a user with a computer-based application. In some embodiments, the method may comprise any of the methods described elsewhere in this description. In some embodiments, the method may be used with or performed by any of the systems and/or apparatus described elsewhere in this description.

In a first set of embodiments of the method, the method comprises the steps of:
receiving (310), by a security server, from the computer-based application a request to perform a security task for the user;
identifying (320), e.g., by the security server, a personal security device associated with the user;
identifying (325), e.g., by the security server, a security operation script corresponding to the security task;
sending (330), by the security server, to the personal security device a request to perform a security operation defined by the security operation script;
receiving (335), by the personal security device, the request to perform a security operation defined by the security operation script;
obtaining (340), by the personal security device, the security operation script;
performing (350), by the personal security device, the security operation script;
returning (360), by the personal security device, to the security server a security operation result of the performing by the personal security device of the security operation script;
receiving (365), by the security server, the security operation result;
determining (370), by the security server, a security task result as a function of the security operation result;
returning (380), but the security server, the security task result to the computer-based application.

More details of the various embodiments of the different aspects of the invention described above are provided in the paragraphs below.

### BRIEF DESCRIPTION OF THE DRAWINGS

The foregoing and other features and advantages of the invention will be apparent from the following, more particular description of embodiments of the invention, as illustrated in the accompanying drawings.

FIG. 1 schematically illustrates an exemplary system according to an aspect of the invention.

FIG. 2 schematically illustrates an exemplary apparatus according to an aspect of the invention.

FIG. 3 schematically illustrates an exemplary method according to an aspect of the invention.

### DETAILED DESCRIPTION

Some implementations of the present invention are discussed below. While specific implementations are discussed, it should be understood that this is done for illustration purposes only. A person skilled in the relevant art will recognize that other components and configurations may be used without parting from the spirit and scope of the invention. Various specific details are provided in order to enable a thorough understanding of the invention. However, it will be understood by a person skilled in the relevant art that the present invention may be practiced without these specific details. In other instances, well-known methods, procedures, components and circuits have not been described in detail so as not to obscure the present invention. Various modifications to the described embodiments will be apparent to persons skilled in the art, and the general principles of the embodiments described in detail below may be applied to other embodiments.

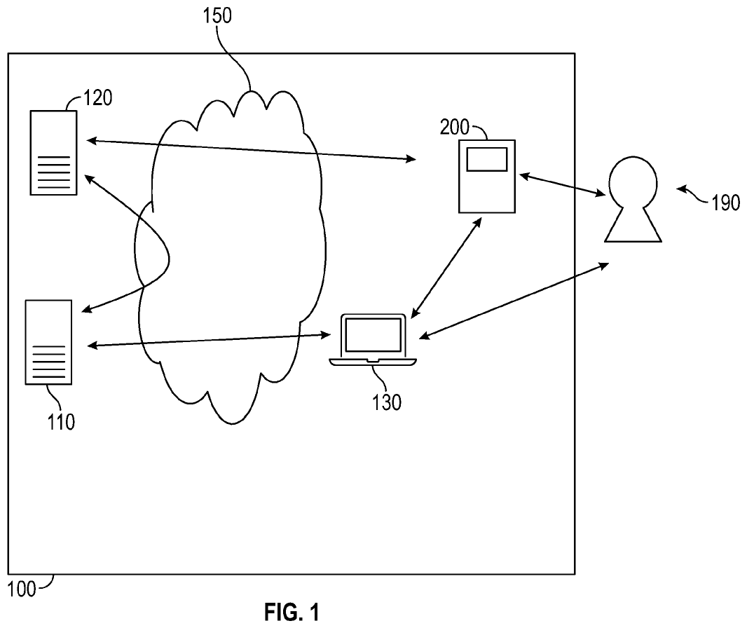

FIG. 1 schematically illustrates an exemplary system (100) according to an aspect of the invention.

In one embodiment a system (100) according to the invention may comprise the following components:
one or more personal security devices (200);
a security server (120), comprising a computer system, the computer system comprising a set of one or more computers.

The system may be adapted to secure the interaction between a user (190) and a remotely accessible computer-based application that may be comprised in or hosted by the application server (110). The user (190) may use the client access device (130) to interact with the computer-based application. For example, the user may use a web browser comprised in the client access device (130) to access a web interface of the computer-based application on the application server (110). Apart from the computer-based application, the application server (110), may further comprise a computer system for hosting the computer-based application, the computer system comprising a set of one or more computers.

The one or more computers of the application server (110) and/or the security server (120) may comprise: one or more digital data processing components for processing digital data, such as for example a microprocessor or a CPU (Central Processing Unit); one or more memory components for storing data or instructions (e.g., software) to be performed by the digital data processing components, like for example a RAM (Random Access Memory) memory or a hard disk, a network interface component, like an Ethernet interface, for connecting the one or more computers of the computer systems of the application server (110) and the security server (120) to each other and/or to a computer network (150) like for example the internet and/or (through computer network (150)) to the personal security device (200) and/or a client access device (130). The computers comprised in the application server (110) are typically physically distinct from the computers comprised in the security server (120). The personal security device (200) and the client access device (130) are typically physically distinct electronic apparatus. The personal security device (200) and the client access device (130) are typically physically distinct from the security server (120) and the application server (110).

The client access device (130) may for example comprise a personal client computing device such as for example a PC (personal computer), a laptop or a tablet computer. The client access device (130) may comprise one or more digital data processing components for processing digital data, such as for example a microprocessor or a CPU (Central Processing Unit); one or more memory components, such as for example a RAM (Random Access Memory) memory or a hard disk, for storing data or instructions (e.g., software such as an operating system like the Windows, Unix, Linux, Apple IOS or the Android operating systems) to be performed by the digital data processing components. The client access device (130) may further also comprise a network interface component, like an Ethernet interface, for connecting the client access device (130) to the application server (110) and/or security server (120).

The computer network (150) may connect the one or more computers of the computer systems the application server (110) and/or security server (120) with each other, with the client access device (130), and, in some cases, with the personal security device (200). In some embodiments, the computer network (150) may comprise the internet. In some embodiments, the computer network (150) may comprise a public telephone network. In some embodiments, the computer network (150) may comprise a wireless telephony network.

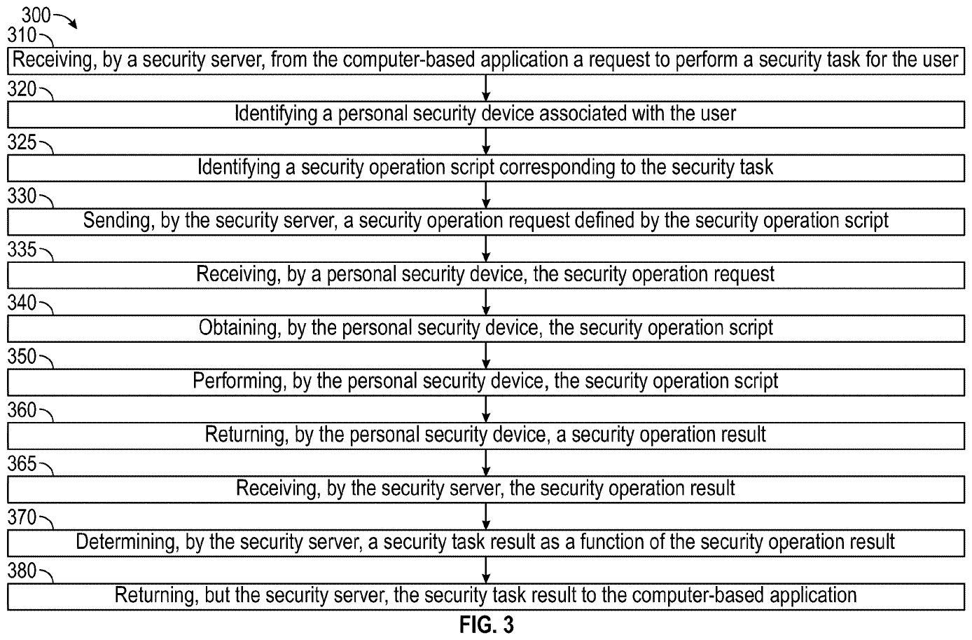

The security server (120) may be adapted to perform the steps of any of the methods for securing the interaction of a user with a computer-based application described elsewhere in this description, which may be performed by a security server. The security server may for example be adapted to perform one or more or all of the steps of the methods described in the discussion of FIG. 3, that may be carried out by the security server. In particular, the security server (120) may be adapted to perform one or more or all of the following steps:
exchange messages with the computer-based application;
receive from the computer-based application a request message to perform a high-level security task (e.g., a user authentication, a transaction data confirmation, ...) for a particular user, wherein the request message comprises: an identifier of the user, and (optionally) a first set of input data and/or parameters for the high-level security task;
identify a personal security device associated with said user;

translate the high-level security task into a security operation to be performed by the personal security device associated with said user;
send a request to perform said security operation to the personal security device associated with said user, wherein the instruction comprises: a script or a reference to a script, and (optionally) a second set of input data and/or parameters for the security operation that may be a function of the first set of input data and/or parameters for the high-level security task;
receive from the personal security device the result of the security task;
determine a result of the high-level security task as a function of the received result of the security operation;
return to the computer-based application a response message that contains the determined result of the high-level security task.

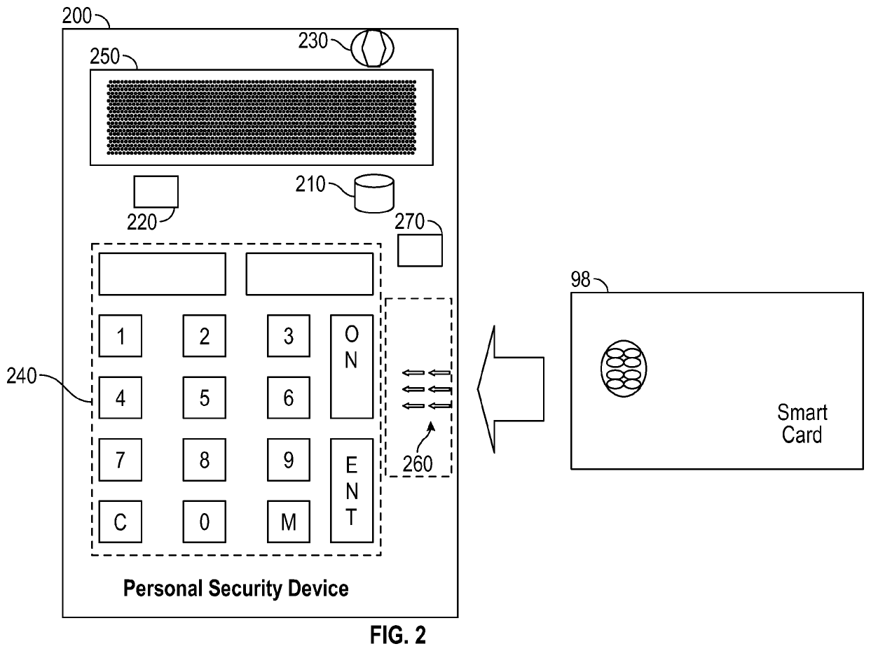

The personal security device (200) may comprise any of the personal security devices described elsewhere in this description, in particular the personal security device described in the discussion of FIG. 2.

FIG. 2 schematically illustrates an exemplary electronic apparatus, i.e., a personal security device (200), according to an aspect of the invention. The personal security device may be adapted for securing the interaction of a user with a computer-based application.

In one embodiment, a personal security device (200) according to the invention may comprise the following components: a memory component (210), and a digital data processing component (220). In some embodiments the electronic apparatus (200) may comprise additional components such as: a user input interface (240) such as for example a keyboard; a user output interface (250) such as for example a display (for example an LCD-Liquid-Crystal Display); a biometric sensor (230) such as for example a fingerprint sensor; one or more wired or wireless digital communication interfaces (270) to communicate with other electronic devices or computers such as for example a USB (Universal Serial Bus) interface or an ethernet interface, or a Bluetooth or Bluetooth Low Energy or a Wi-Fi or IEEE 802.11 interface, or a wireless data interface adapted to communicate over mobile telephony data network; additional digital communication interfaces (260) to interface with other electronic devices or removable components (98), such as for example one or more smart card readers to communicate with an inserted smart card (98), such as a banking smart card (for example an EMV (Europay-Mastercard-VISA) debit or credit card), or a SIM (Subscriber Identity Module) card, or some other form of a secure module capable of securely storing secret data such as cryptographic keys and/or PIN or password reference data and/or biometric templates and capable of performing cryptographic calculations parameterized with the aforementioned stored cryptographic keys; and a power supply such as a battery or a power cable. In some embodiments, such removeable components may also be comprised in the personal security device.

The personal security device may be adapted to perform cryptographic operations. For example, the personal security device may be adapted to generate electronic signatures or dynamic authentication credentials. In some embodiments, the personal security device may be dedicated to a security related function such as for example securing the interaction of a user with a computer-based application, for example by generating electronic signatures and/or dynamic authentication credentials, such as One-Time Passwords (OTPs). It may for example comprise an (intelligent and secure) smart card reader. In other embodiments, it may for example comprise a personal electronic device such as a smartphone or a smartwatch comprising a client authentication app.

In some embodiments, the personal security device may be adapted to perform some cryptographic operations in cooperation with a removeable component (98) whereby the actual cryptographic calculations may be done partly or entirely by the removeable component (98).

The memory component (210) may be adapted to store firmware instructions for the digital data processing component (220) to read and execute. The memory component (210) may be further adapted to store data for the digital data processing component (220) to read, process and write. In particular, the memory component (210) may be adapted to store one or more secret and/or security sensitive data elements, such as for example secret cryptographic keys and/or reference data for PIN or password validation or one or more biometric templates. The memory component may comprise volatile and/or non-volatile memory, such as for example one or more RAM (Random Access Memory) chips, ROM (Read-Only Memory) chips, EEPROM (Electrically Erasable Programmable Read-Only Memory), flash memory, hard disk drives, . . . . In some embodiments, the personal security device may rely on a removeable component (98) for storing one or more secret and/or security sensitive data elements.

The digital data processing component (220) may be connected, for example by means of a bus, to the memory component (210) and various other components of the personal security device such as the aforementioned biometric sensor (230), user input interface (240), user output interface (250), digital communication interfaces (270) and additional digital communication interfaces (260). The digital data processing component (220) may be adapted to read and execute firmware instructions stored on the memory component. The digital data processing component (220) may be adapted to read digital data that are stored on or in the memory component (210), to process digital data and to store digital data on or in the memory component. The digital data processing component (220) may be adapted to control various components of the personal security device such as the aforementioned biometric sensor (230), user input interface (240), user output interface (250), digital communication interfaces (270) and additional digital communication interfaces (260).

The functionality of the personal security device (200) may be at least partly defined and implemented by the firmware stored on the memory component (210) to be read and executed by the digital data processing component (220).

In some embodiments, the personal security device may be adapted to perform the steps of any of the methods for securing the interaction of a user with a computer-based application described elsewhere in this description, which may be performed by a personal security device.

The personal security device may for example be adapted to perform one or more or all of the steps of the methods described in the discussion of FIG. 3, that may be carried out by the personal security device.

In particular, the personal security device may be associated with a particular user and may be adapted to perform the following actions as part of a method for securing the interaction between that user and a computer-based application:
store in said memory a secret cryptographic master key;
receive and perform instructions from the security server;
perform a security operation pursuant to an instruction received from the security server, wherein performing the security operation comprises:
   performing a cryptographic algorithm that is parameterized with a secret cryptographic application key, wherein the cryptographic application key may be derived from and/or obtained using the secret cryptographic master key stored in said memory;
   the personal security device interacting with the user (e.g., presenting data for review; receiving confirmation; authenticating the user by means of for example a PIN or a biometrics, . . . );
   wherein the flow of the security operation is defined by a script (i.e., micro application; p-app) that the personal security device has received from the security server;
return a result of the security operation to the security server.

In some embodiments, the discussed personal security device may be comprised in any of the systems described elsewhere in this description. In particular, the personal security device may be comprised in any of the systems described in the discussion of FIG. 1.

The system may for example be used and operated as follows. When a computer-based application needs some security task to be performed in relation to a particular user (such as authenticating the user, or confirming a transaction purportedly submitted by the user), the computer-based application may request the security server to perform this security task in relation to this particular user. The security server may perform the security task as follows. The security server may determine a security operation to be performed by a personal security device associated with this particular user, whereby the security operation may be determined as a function of the security task. The personal security device may be identified, e.g., as a function of the user, for example, by the security server. The security server may then request the personal security device to perform the determined security operation. The personal security device may then perform the security operation and return a result of performing the security operation to the security server. The security server may receive this security operation result and determine a result of the security task as a function of the received result of the security operation performed by the personal security device. The security server may then return this determined result of the security task to the computer-based application.

The security server may be adapted to exchange messages with the computer-based application. To request the security server to perform a security task in relation to a particular user, the computer-based application may send to the security server one or more security task request messages comprising the request to perform the security task. Inversely, to return a determined result of the security task to the computer-based application the security server may send one or more security task result messages to the computer-based application. The computer-based application and the security server may apply cryptographic secure messaging techniques to these security task request messages and these security task result messages, and possibly also to other messages that are exchanged between the computer-based application and the security server, in order to guarantee the authenticity, and/or the integrity, and/or the confidentiality, and/or non-repudiation of these messages and/or the contents of these messages and/or to guarantee that these messages cannot be replayed. In some embodiments, the secure messaging techniques may be applied to these messages as a whole. In other embodiments, the cryptographic secure messaging techniques may be applied to the contents or parts of the contents of these messages. For example, in some embodiments the messages or the contents of these messages or parts of the contents of these messages may be encrypted to guarantee the confidentiality of the contents of these messages. In other embodiments, the messages or the contents of these messages or parts of the contents of these messages may be provided with a cryptographic checksum or electronic signature to guarantee the integrity of the messages and/or the contents of the messages and/or to authenticate the sender of a message.

### Security Task Request Contents

In some embodiments, a security task request may comprise an identifier of a security task to be performed by the security server. In some embodiments, a security task request may comprise an identifier of the particular user for which the security server is requested to perform the security task. In some embodiments, a security task request may comprise a first set of one or more data elements that serve as input data for the security task to be performed by the security server. For example, in some embodiments a security task request may comprise a request to confirm the authenticity of a particular transaction and the security task request may furthermore comprise one or more transaction data elements that together represent the particular transaction to be confirmed.

### Security Task Result Types

In some embodiments, the result of the security task, as determined by the security server and returned to the computer-based application, may comprise a binary value that may indicate whether or not the security task was successfully performed. For example, in some embodiments the security task may comprise authenticating the user and the result of the security task may indicate whether the user was successfully authenticated or not; or the security task may comprise the user confirming a transaction and the result of the security task may indicate whether the user has indeed confirmed the transaction or not. In other embodiments, the result of the security task may have a value taken from a discrete set of possible values. In other embodiments, the result of the security task may have a value taken from a continuous set of possible values. For example, in some embodiments the result may indicate a probability that the user is indeed the person they claim to be, or a probability that a transaction that the computer-based application has received is indeed a transaction that has been submitted by a legitimate user. In still other embodiments, the result of the security task may comprise a set of data. For example, in some embodiments the security task may comprise obtaining a non-repudiable proof that a user agrees with the contents of a document and the result of the security task may comprise a non-repudiable digital signature of that document.

### Identifying the Personal Security Device

In some embodiments, the security server may be adapted to obtain an identifier of the personal security device as a function of an identifier of the user that the security server may receive from the computer-based application, for example, as part of the security task request. For example, the security server may have a database comprising records that link user identifiers to the identifiers of the personal security devices that are associated with the users of these user identifiers and the security server may obtain the identifier of a personal security device associated with the user corresponding to a particular user identifier by looking up a record in this database containing that particular user identifier and taking from that record the identifier of the personal security device linked in the record to that user identifier.

### Communication Between the Security Server and the Personal Security Device

The security server may be adapted to exchange messages with a personal security device. To request the personal security device to perform a security operation, the security server may send to the personal security device one or more security operation request messages comprising the request to perform the security operation.

Inversely, to return a determined result of the security operation to the security server the personal security device may send one or more security operation result messages to the security server. The security server and the personal security device may apply cryptographic secure messaging techniques to these security operation request messages and these security operation result messages, and possibly also to other messages that are exchanged between the security server and the personal security device, in order to guarantee the authenticity, and/or the integrity, and/or the confidentiality, and/or non-repudiation of these messages and/or the contents of these messages and/or to guarantee that these messages cannot be replayed. In some embodiments, the secure messaging techniques may be applied to these messages as a whole. In other embodiments, the cryptographic secure messaging techniques may be applied to the contents or parts of the contents of these messages. For example, in some embodiments the messages or the contents of these messages or parts of the contents of these messages may be encrypted to guarantee the confidentiality of the contents of these messages. In other embodiments, the messages or the contents of these messages or parts of the contents of these messages may be provided with a cryptographic checksum or electronic signature to guarantee the integrity of the messages and/or the contents of the messages and/or to authenticate the sender of a message.

In typical embodiments, there is no cryptographically end-to-end secured connection between on the one hand a computer-based application and on the other hand a personal security device of a user of the computer-based application. Instead, there may be on the one hand a cryptographically end-to-end secured connection between the computer-based application and the server and on the other hand another cryptographically end-to-end secured connection between the security server and the personal security device of the user of the computer-based application. However, in some specific embodiments, the security server may be used to enable the establishment of a cryptographically end-to-end secured connection between on the one hand a computer-based application and on the other hand a personal security device of a user of the computer-based application. For example, in some specific embodiments the security server may relay key-exchange messages between the computer-based application and the user's personal security device. In such embodiments, the establishment of a cryptographically end-to-end secured connection between on the one hand a computer-based application and on the other hand a personal security device of a user of the computer-based application may be a security task that the computer-based application may request from the security server.

### Transporting Messages Between the Security Server and a Personal Security Device

In some embodiments, the personal security device's digital communication interfaces (270) comprise an interface to connect the personal security device to a computer network that the security server is also connected to. For example, in some embodiments the personal security device's digital communication interfaces (270) may comprise an Ethernet interface or a Wi-Fi interface or an interface for a cellular mobile data network such as a 3G, 4G or 5G mobile telephony data network (for example, a UMTS (Universal Mobile Telecommunications System), LTE (Universal Mobile Telecommunications System), or 5G NR 5NewRadio) data network). The security server and the personal security device may then exchange the messages discussed above by means of that computer network. In other embodiments, the personal security device's digital communication interfaces (270) may comprise a wired or wireless data communication interface (such as a USB (Universal Serial Bus) or Bluetooth interface) for locally connecting the user's personal security device to the user's client access device (130). The security server and the personal security device may then exchange the messages discussed above by using the user's client access device that the personal security device is locally connected to as a relay station for relaying messages that the security server and the personal security device exchange with each other. In particular, the security server may send messages that are destined for the personal security device to the user's client access device over a computer network (such as the Internet) that both the security server and the user's client access device are connected to, and the user's client access device may forward these messages to the user's personal security device over the local connection between the user's client access device and the user's personal security device; and the personal security device may send messages that are destined for the security server to the user's client access device over the local connection between the user's client access device and the user's personal security device, and the user's client access device may forward these messages to the security server over the computer network that both the security server and the user's client access device are connected to. For this purpose, the user's client access device may comprise a piece of software adapted to perform this relaying of messages between the security server and the user's personal security device. In some embodiments, the security server may obtain the network address from the computer-based application. In other embodiments, the aforementioned piece of software may inform the security server which client access device a personal security device is connected to, for example, when the personal security device connects to the client access device.

### Security Operation Request Contents

The security operation request may comprise a script or a reference to (or identifier of) a script of the security operation to be performed by the personal security device. In what follows, a script of a security operation to be performed by the personal security device may be referred to as a security operation script or simply as a script. In some embodiments, the security operation request may comprise the entire security operation script itself. In some embodiments, a security operation script may be discarded by the personal security device after the personal security device has performed the script. In other embodiments, the personal security device may be adapted to cache security operation scripts. I.e., the security operation request may comprise only a reference to (or an identifier of) the security operation script, which the personal security device may use to obtain the actual script. For example, in some embodiments the personal security device may be adapted to store in memory security operation scripts that it has received and to use the reference or identifier to identify to correct script among the stored scripts. If the correct script indicated by the reference or identifier comprised is among the scripts stored in memory, the personal security device may retrieve the correct script from memory and use the retrieved script when performing the requested security operation. If the correct script indicated by the reference or identifier comprised is not among the scripts stored in memory (e.g., because the personal security device had not yet received the script or because it has in the meantime already been removed from memory), the personal security device may use the reference or identifier to obtain the correct script from another source. For example, the personal security device may be adapted to send a message to the security server to request the security server to send a particular script to the personal security device.

In some embodiments, a security operation request may comprise a second set of one or more data elements that serve as input data for the security operation to be performed by the personal security device. The data elements of the second set of one or more data elements may be referenced and used by a script comprised in or referenced by the security operation request. For example, in some embodiments a security operation request may comprise a request to confirm the authenticity of a particular transaction and the security operation request may furthermore comprise one or more transaction data elements that together represent the particular transaction to be confirmed. Other types of data elements that may be comprised in the second set of one or more data elements may comprise for example: messages to be presented by the personal to the user of the personal security device, challenges to be used for example by a cryptographic function (such as a challenge-response authentication function) that the personal security device may perform when performing the script, a reference or label to a cryptographic key or other cryptographic algorithm parameters to be used by the personal security device to parameterize a cryptographic function that the personal security device may perform when performing the script.

### Security Operation Scripts

The personal security device may be adapted to perform a security operation script (“script”) to perform a security operation requested by the security server. The script is a micro application (μ-app) that provides instructions to the personal security device for processing transaction data. The μ-app itself does not include the transaction data. Rather, the transaction data may be transferred along with the μ-app. The security device processes the transaction data in accordance with the instructions in the accompanying μ-app. Unlike traditional programming language applications, in which there are many instructions where a programmer (or hacker) has the opportunity to access and process transaction data, the μ-app does not provide that power since security/confidentiality operations on the transaction data are processed in the personal security device (not in the μ-app).

The micro application (μ-app) may be a signed script, with the personal security device only accepting scripts with a valid signature. Signed scripts reside in the security or application server. Signing of a script is performed (or commanded) by the producer/manufacturer of the personal security device, such that only trusted scripts are being processed within the personal security device, ensuring that responsibilities are clear and cannot be compromised.

In some embodiments, the personal security device may receive the security operation script as part of the security operation request that it receives from the security server. In other embodiments, the personal security device may receive (as part of the security operation request that it receives from the security server) a reference to or an identifier of the security operation script and the personal security device may be adapted to use this reference or identifier to retrieve or obtain the security operation script to perform. A security operation script may comprise a sequence of high level instructions to be performed by the personal security device. These high level instructions may instruct the personal security device to perform certain high level functions such as: performing a particular cryptographic algorithm; and/or presenting a message and/or data to the user for informing the user or for allowing the user to confirm or approve or to refuse or cancel the message and/or data being presented; and/or obtaining such a confirmation or approval or such a refusal or cancellation; and/or prompting the user to provide an input to the personal security device and capturing that input of the user (such as for example prompting the user to enter the value of a particular data element and capturing the value subsequently entered by the user); and/or performing a local authentication of the user (see further for details); and/or comparing values of data elements (such as input data of the script, and/or results of high level functions already performed in the course of performing the script, and/or constant values embedded in the script) with each other; and/or converting the format of a data element from one format to another (e.g., converting the representation of a number from a binary format to a BCD (Binary Coded Decimal) format or an ASCII format). The high level functions that may be referenced in a security operation script may be parameterized by data elements such as input data of the script, and/or results of high level functions already performed in the course of performing the script, and/or constant values embedded in the script. The personal security device performing a high level function referenced in a security operation script may result in the generation of one or more data values that may be used as input data for high level functions referenced in the security operation script and subsequently performed by the personal security operation or that may be used to determine the result of the security operation script.

In some embodiments, a security operation script consists of a sequence of instructions that are performed by the personal security device linearly from the beginning of the script to the end. In other embodiments, a security operation script may comprise conditional branch instructions whereby the personal security device may chose to perform one of a set of sub-sequences of instructions comprised in the security operation script whereby the choice of which sub-sequence of instructions to perform may depend on the value of a condition that may be a function of data elements such as input data of the script, and/or results of high level functions already performed in the course of performing the script, and/or constant values embedded in the script.

In some embodiments, a security operation script may comprise instructions for the personal security device to store values in the memory of the personal security device and/or to retrieve stored values from the memory of the personal security device. In some embodiments, a value may thus be stored in memory during the performing by the personal security device of one security operation script and retained in memory after the performing of the security operation script has been completed, and the value thus stored and retained in the memory of the personal security device may subsequently be retrieved during the performing by the personal security device of another security operation script.

### Cryptographic Nature of Security Operations

In a typical embodiment, a personal security device performing a security operation requested by the security server and returning the result of the security operation to the security server comprises the personal security device performing one or more cryptographic operations that consist of performing a cryptographic algorithm that is parameterized by a secret cryptographic key. Such a secret cryptographic key may be unique for any particular personal security device and may be comprised in the unique personality of such particular personal security device. In some embodiments, such a secret cryptographic key may be (permanently) stored in the memory of the personal security device. In some embodiments, such a secret cryptographic key may be dynamically derived from other data elements such as data elements comprised in the personal security device's unique personality and may be discarded after use. Such cryptographic algorithms may comprise symmetric or asymmetric encryption or decryption algorithms, digital signature algorithms, electronic signature algorithms, cryptographic checksum algorithms, keyed-hash algorithms. In some embodiments, such cryptographic operations may be performed by the personal security device when performing a security operation script that the personal security device performs to perform the requested security operation. A cryptographic operation may be part of a high level function that may be referenced in a security operation script. In some embodiments, such cryptographic operations may be performed when the personal security device applies secure messaging techniques for securing messages exchanged with the security server such as messages to return the result of the security operation to the security server.

### Unique personlity of the Personal Security Devices

Each personal security device of the one or more personal security devices (200) comprised in the system (100) has a unique personality that distinguishes any particular personal security device from any other personal security device of the one or more personal security devices (200) comprised in the system (100). This unique personality is a set of data elements whereby two personal security devices are distinguished from each other by having different values for the data elements making up their unique personality. In some embodiments, some data elements of the unique personalities of two different personal security devices may have the same values, but whereby at least some data elements of the unique personalities of these two different personal security devices have different values. A personal security device's personality may comprise secret and non-secret data elements. A personal security device's personality may comprise an identifier (such as a serial number) of the personal security device. In some embodiments a personal security device's identifier may be a non-secret data element. A personal security device's personality may comprise one or more secret data elements such as secret cryptographic keys. In some embodiments, a personal security device may use one or more secret cryptographic keys of its unique personality in performing a security operation requested by the security server and returning the result of the security operation to the security server.

In some embodiments, the values of at least some data elements of the personality of a personal security device may be set prior to the distribution of the personal security device to a user, e.g., during the manufacturing of the personal security device. Such data elements may include for example an identifier of the personal security device such as the serial number of the personal security device and/or a unique secret cryptographic master key. The values of these data elements may be set in a secure setting. A secret cryptographic master key may be a symmetric key (for use with symmetric cryptographic algorithms) or the private key of a public-private master key pair. The secure server may be informed of the identifier of the personal security device together with the value of a corresponding symmetric cryptographic master key or the value of the public key of the public-private master key pair corresponding to the personal security device's identifier. In a later stage, for example after distribution of the personal security device to the user, the values of other data elements of the personal security device's personality (such as for example cryptographic keys used in the secure message techniques applied to messages exchanged between the personal security device and the secure server, or cryptographic keys used by the personal security device for performing a security operation script) may be set. To obtain the values for these other data elements, the personal security device may use a secret cryptographic master key comprised in the personal security device's personality. For example, the personal security device may use the secret cryptographic master key in a key derivation algorithm or in a key exchange protocol with the security server.

In some embodiments at least some of the data elements of the personal security device's personality may be referenceable and usable in a security operation script performed by the personal security device. In some embodiments, the way that such a data element of the personal security device's personality can be used in a security operation script may be constrained depending on the type of the data element. For example, in some embodiments a personal security device's identifier may be used in any possible way that a data element previously stored in the memory of the personal security device by a script might be used, while a data element that is a cryptographic key may only be used to parameterize a cryptographic algorithm.

### Local User Authentication

In some embodiments, authenticating a user may be a typical security task. In general, users may be authenticated based on one or more of three factors, namely, something the user has, something the user knows, and something the user is. A particular personal security device may be an embodiment of the something-the-user-has factor, whereby a personal security device may be associated with a particular user and whereby that particular personal security device may have its own unique identity. The particular personal security device may be adapted to demonstrate or prove its identity to the security server by cryptographic techniques known in the art.

In some embodiments, the personal security device may further be adapted to support authenticating a user on the basis of the something-the-user-knows factor. For example, in some embodiments the personal security device may be adapted to have the capability to prompt (e.g., by means of a human output interface of the personal security device) the user to enter (e.g., by means of a human input interface of the personal security device) a particular piece of knowledge that the user may have, such as for example the value of a PIN (Personal Identification Number) or password. In some embodiments, the personal security device may be adapted to have the capability to locally authenticate the user. For example, the personal security device may be adapted to store a reference value for that particular piece of knowledge (such as an expected value for the particular piece of knowledge entered by the user, or a hash of an expected value for the particular piece of knowledge entered by the user) and may be adapted to have the capability of comparing the value that was entered by the user to the stored reference value. In some embodiments, the personal security device may deem the user to be the legitimate user (i.e., to user to be authenticated) if the value entered by the user is found by the personal security device to match the stored reference value. In other embodiments, the personal security device may use the value entered by the user in generating the security operation result. In some embodiments, the personal security device may use the value entered by the user as a parameter for parameterizing a cryptographic algorithm that the personal security device may use to calculate the security operation result (or a part thereof). For example, in some embodiments the personal security device may use the value entered by the user in the generation or derivation of a cryptographic key that it may then use for generating a security operation result. For example, in some embodiment the personal security device may combine the value entered by the user with a secret value stored in the personal security device to generate a symmetric cryptographic key that the personal security device may use to generate a cryptographic credential such as a one-time password or a transaction data signature. In other embodiments the personal security device may use the value entered by the user as an input data element for generating the security operation result. For example, in some embodiments the personal security device may encrypt the entered value or a value derived from the entered value and include the encrypted value in the security operation result. The security server may retrieve the encrypted value from the security operation result that it receives from the personal security device and decrypt it and compare the decrypted value to a reference value that it may have stored. In some embodiments, the security server may deem the user to be successfully authenticated if the decrypted value is found by the security server to match the reference value stored at the security server.

In some embodiments, the personal security device may further be adapted to support authenticating a user on the basis of the something-the-user-knows factor. For example, in some embodiments, the personal security device may comprise a biometric sensor, such as for example a fingerprint sensor, for capturing a biometric measurement of a biometric feature (such as fingerprint) of the user. In some embodiments, the personal security device may be adapted to have the capability to locally authenticate the user. For example, the personal security device may store a biometric template (such as a fingerprint template) of the user and may be adapted to have the capability to compare a biometric measurement captured with the biometric sensor to the stored biometric template. In some embodiments, the personal security device may deem the user to be the legitimate user (i.e., to user to be locally authenticated) if the biometric measurement of a biometric feature of the user captured by the biometric sensor of the personal security device is found by the personal security device to match the stored biometric template. Alternatively, the personal security device may determine a probability that the user is the legitimate user as a function of the degree that the biometric measurement of a biometric feature of the user captured by the biometric sensor of the personal security device is found by the personal security device to match the stored biometric template. In other embodiments, the personal security device may use the captured biometric measurement of a biometric feature of the user in generating the security operation result. In some embodiments the personal security device may use the captured biometric measurement of a biometric feature of the user as an input data element for generating the security operation result. For example, in some embodiments the personal security device may encrypt the captured biometric measurement of a biometric feature of the user and include the encrypted biometric measurement in the security operation result. The security server may retrieve the encrypted biometric measurement from the security operation result that it receives from the personal security device and decrypt it and compare the decrypted biometric measurement with a reference biometric template of the user that it may have stored. In some embodiments, the security server may deem the user to be successfully authenticated if the decrypted biometric measurement is found by the security server to match the biometric template stored at the security server.

### Local User Authentication as a Scriptable Capability

The personal security device may be adapted to have the capability of locally authenticating the user and to offer this capability as a high level function that may be referenced in a security operation script, whereby the result of this high level local authentication function may comprise a value indicating whether or not the personal security device deems the user to be the legitimate user or a value indicating a probability that the user is the legitimate user.

### Multiple Computer-Based Applications

In some embodiments, a particular user may be a user of many computer-based applications and several of these computer-based applications may all rely on the same security server for the performance of various security tasks for the same particular user wit the same personal security device. In such embodiments, a security task request may comprise an explicit or implicit indication of the computer-based application that requests the performance of the security task. In some embodiments, different computer-based applications may rely on the security server for the performance of security tasks that the security server may map on identical security operation scripts that require as input data an identifier of a cryptographic key of the user's personal security device but whereby the security server may determine the identifier of the cryptographic key of the user's personal security device as a function of the computer-based application that has requested the security task that the security server maps on the security operation.

### Exemplary Embodiment

In an exemplary embodiment, the computer-based application may comprise a bank's internet banking application. The internet banking application may have a web interface and may be hosted by a web server of the bank. A customer of the bank, i.e., may remotely access the internet banking application using a web browser on a PC. When the customer, i.e., the user of the internet banking application, tries to log in into their internet banking application account, the internet banking application may need to authenticate the user. To authenticate the user, the internet banking application may request the security server to perform the task of the authenticating the user. The internet banking application may send the security server a security task request that comprises an identifier of the user and an indication that the security task to be performed is authenticating the user. The security server may identify a personal security device that is associated with the user. To perform the security task of authenticating the user, the security server may request the personal security device to perform the security operation of generating and returning a one-time password (OTP) for the customer. The security server may identify an appropriate script defining the security operation of generating and returning an OTP. The script may for example define that the OTP shall be generated by the personal security device reading the time of a real-time clock comprised in the personal security device, formatting the time value in a particular format, encrypting the formatted time with a particular encryption algorithm, and determining the OTP as a function of the resulting encrypted value. The script may define how the time should be formatted, which encryption algorithm should be used (e.g., AES-Advanced Encryption Standard), and how the OTP should be determined as a function of the encrypted time value. The script may further prescribe that the personal security device must first locally authenticate the user on the basis of a PIN, i.e., by prompting the user to enter a PIN (Personal Identification Number) and comparing the PIN value entered by the user with a PIN reference value stored in the personal security device; whereby the script may prescribe that the personal security device shall generate and return the OTP only of the entered PIN matches the PIN reference value. To communicate to the personal security device the request to generate and return the OTP, the security server may send one or more security operation request messages to the personal security device. These security operation request messages may comprise the script or a reference to the script. The security operation request messages may further comprise an identifier of a secret cryptographic key that the personal security device must use to parameterize the encryption algorithm for encrypting the formatted time value. Upon receiving the security operation request messages, the personal security device may verify the authenticity of the messages (i.e., that they effectively come from the genuine security server) and the integrity of the messages (i.e., that the contents of the messages has not been corrupted). Thereafter, the personal security device may execute the script contained or referenced in the received security operation request. If the user has entered a PIN value that matches the stored PIN reference value, the personal security device may generate the OTP and include the generated OTP in the result of the security operation. If the user has not entered a PIN value that matches the stored PIN reference value or otherwise cancelled the security operation, the personal security device may include in the result of the security operation an indication that the security operation was not successful. The personal security device then returns this security operation result in one or more security operation result messages that it sends to the security server. The personal security device may apply secure messaging mechanisms to these messages for protecting the confidentiality of the contents of these messages and so that the security server may verify the authenticity and integrity of these messages. After receiving the security operation result, the security server may determine the security task result as a function of the received security operation result. If the received security operation result includes an indication that the security operation was not successful then the security server may include in the security task result an indication that the user has not been successfully authenticated. If the received security operation result includes an OTP then the security server may validate the received OTP. If the OTP turns out to be valid then the security server may include in the security task result an indication that the user has been successfully authenticated. If the OTP does not turn out to be valid then the security server may include in the security task result an indication that the user has not been successfully authenticated. The security server may then return the security task result to the computer-based application by sending the computer-based application one or more security task result messages that comprise the security task result. The security server may apply secure messaging mechanisms to these messages for protecting the confidentiality of the contents of these messages and so that the computer-based application may verify the authenticity and integrity of these messages. Upon receiving the security task result, the computer-based application may take certain actions depending on the received security task result. For example, if the received security task result contains an indication that the user has not been successfully authenticated then the computer-based application may refuse the login attempt of the user; while if the received security task result contains an indication that the user has been successfully authenticated then the computer-based application may accept the login attempt of the user.

### Transaction Data Signing

When the user has thus been logged in into their internet banking application account, the user may want to transfer an amount of money from their account to another account. To do the money transfer, the user may submit a money transfer transaction to the internet banking application that specifies the user's source account, the destination account and the amount and currency of the money to be transferred. Before accepting and executing the submitted money transfer transaction, the internet banking application may need to have the money transfer transaction confirmed.

To confirm the submitted money transfer transaction, the internet banking application may request the security server to perform the task of confirming the submitted money transfer transaction. The internet banking application may send the security server a security task request that comprises an identifier of the user, an indication that the security task to be performed is confirming a transaction and the security sensitive transaction data, i.e., the destination account and the amount and currency of the money to be transferred. The security server may identify a personal security device that is associated with the customer. To perform the security task of confirming the transaction, the security server may request the personal security device to perform the security operation of confirming a transaction. The security server may identify an appropriate script defining the security operation of confirming a transaction. The script may prescribe that the personal security device must first locally authenticate the user on the basis of a PIN, i.e., by prompting the user to enter a PIN (Personal Identification Number) and comparing the PIN value entered by the user with a PIN reference value stored in the personal security device; whereby the script may prescribe that the personal security device shall abort the security operation of confirming the transaction if no matching PIN has been entered by the user. The script may for further define that the personal security device must present each of the transaction data elements (that are passed as input data for the script in the security operation request) to the user for the user to review and confirm or cancel, and generate an electronic signature of the transaction data elements if all transaction data elements have been confirmed by the user. To communicate to the personal security device the request to perform the security operation of confirming the transaction, the security server may send one or more security operation request messages to the personal security device. These security operation request messages may comprise the script or a reference to the script and may further comprise the transaction data as input data for the script. The security operation request messages may further comprise an identifier of a secret cryptographic key that the personal security device must use to generate the electronic signature of the transaction. Upon receiving the security operation request messages, the personal security device may verify the authenticity of the messages (i.e., that they effectively come from the genuine security server) and the integrity of the messages (i.e., that the contents of the messages have not been corrupted). Thereafter, the personal security device may execute the script contained or referenced in the received security operation request. If the user has entered a PIN value that matches the stored PIN reference value, the personal security device may continue with presenting to the user the transaction data one after the other for the user to review and confirm or cancel. If the user has confirmed all transaction data then the personal security device may generate an electronic signature of the transaction data using the cryptographic key corresponding to the cryptographic key identifier in the security operation request message, and the personal security device may include the generated electronic signature in the result of the security operation. If the user fails to enter a PIN value that matches the stored PIN reference value, cancels one of the transaction data elements or otherwise cancelled the security operation, the personal security device may include in the result of the security operation an indication that the security operation was not successful. The personal security device then returns this security operation result in one or more security operation result messages that it sends to the security server. The personal security device may apply secure messaging mechanisms to these messages for protecting the confidentiality of the contents of these messages and so that the security server may verify the authenticity and integrity of these messages. After receiving the security operation result, the security server may determine the security task result as a function of the received security operation result. If the received security operation result includes an indication that the security operation was not successful then the security server may include in the security task result an indication that the transaction has not been successfully confirmed. If the received security operation result includes an electronic signature then the security server may validate the received electronic signature. If the electronic signature turns out to be valid (i.e., if the electronic signature matches the transaction data that the security server received from the computer-based application and provided to the personal security device) then the security server may include in the security task result an indication that the transaction has been successfully confirmed. If the electronic signature does not turn out to be valid then the security server may include in the security task result an indication that the transaction has not been successfully confirmed. The security server may then return the security task result to the computer-based application by sending the computer-based application one or more security task result messages that comprise the security task result. The security server may apply secure messaging mechanisms to these messages for protecting the confidentiality of the contents of these messages and so that the computer-based application may verify the authenticity and integrity of these messages. Upon receiving the security task result, the computer-based application may take certain actions depending on the received security task result. For example, if the received security task result contains an indication that the transaction has not been successfully authenticated then the computer-based application may reject the submitted money transfer transaction; while if the received security task result contains an indication that the transaction has been successfully confirmed then the computer-based application may accept and execute the submitted money transfer transaction.

FIG. 3 schematically illustrates an exemplary method for securing the interaction of a user with a computer-based application according to an aspect of the invention.

In some embodiments, a method (300) according to the invention may comprise the following steps:
receiving (310), by a security server, from the computer-based application a request to perform a security task for the user;
identifying (320), e.g., by the security server, a personal security device associated with the user;
identifying (325), e.g., by the security server, a security operation script corresponding to the security task;
sending (330), by the security server, to the personal security device a request to perform a security operation defined by the security operation script;
receiving (335), by the personal security device, the request to perform a security operation defined by the security operation script;
obtaining (340), by the personal security device, the security operation script;
performing (350), by the personal security device, the security operation script;
returning (360), by the personal security device, to the security server a security operation result of the performing by the personal security device of the security operation script;
receiving (365), by the security server, the security operation result;
determining (370), by the security server, a security task result as a function of the security operation result;
returning (380), but the security server, the security task result to the computer-based application.

Advantages and disadvantages of the invention or various embodiments of the invention.

### Flexibility

Because the security server maps security tasks requested by computer-based applications on security operations that are defined by security operation scripts to be performed by personal security devices, it is easy and practically feasible to update the way that security tasks are being handled in view of changing security requirements, without having to replace the personal security devices.

### Multiple Applications

The invention makes it possible for different multiple computer-based applications to share the same personal security device for a particular user even if these different multiple computer-based applications have different security needs and even if it would not be acceptable for these different multiple computer-based applications to trust each other (e.g., to share cryptographic keys).

### Security

The flexibility of the security operation scripts and the possibility for the security operation scripts to be parameterized with different cryptographic keys depending on the compute-based application requesting a security task, allows to apply at any given time the most appropriate level of security for every different transaction or user interaction.

### Cost-Effectiveness

Since the invention makes it possible for different multiple computer-based applications to share the same personal security device for a particular user, the costs of such a device can be effectively shared between these multiple computer-based applications.

A number of implementations have been described. Nevertheless, it will be understood that various modifications may be made. For example, elements of one or more implementations may be combined, deleted, modified, or supplemented to form further implementations.

Accordingly, other implementations are within the scope of the appended claims. In addition, while a particular feature of the present invention may have been disclosed with respect to only one of several implementations, such feature may be combined with one or more other features of the other implementations as may be desired and advantageous for any given or particular application. While various embodiments of the present invention have been described above, it should be understood that they have been presented by way of example only, and not limitation. In particular, it is, of course, not possible to describe every conceivable combination of components or methodologies for purposes of describing the claimed subject matter, but one of ordinary skill in the art may recognize that many further combinations and permutations of the present invention are possible. Thus, the breadth and scope of the present invention should not be limited by any of the above-described exemplary embodiments; rather the scope of at least one embodiment of the invention is defined only in accordance with the following claims and their equivalents.

1. A system for securing interaction of a user with a computer-based application, the system comprising:
a security server configured to:
receive from the computer-based application a request to perform a security task for the user;
identify a security operation script corresponding to the security task;
send to a personal security device of the user a request to perform a security operation defined by the security operation script;
receive from the personal security device a security operation result of performing the security operation script;
determine a security task result as a function of the security operation result; and
return the security task result to the computer-based application.

2. The system of claim 1, wherein the security server is further configured to:
identify from among a plurality of personal security devices the personal security device associated with the user;
wherein the request to perform the security operation defined by the security operation script is sent by the security server to the identified personal security device associated with the user.

3. The system of claim 1, wherein the system further comprises:
the personal security device of the user, wherein the personal security device of the user is configured to:
receive from the security server the request to perform the security operation defined by the security operation script;
perform the security operation script; and
return to the security server a security operation result of performing the security operation script.

4. The system of claim 3, wherein the personal security device is further configured to:
obtain the security operation script defining the security operation requested by the security server.

5. The system of claim 4, wherein the request to perform the security operation defined by the security operation script comprises an identifier of the security operation script and the personal security device obtains the security operation script using the identifier of the security operation script.

6. The system of claim 1, wherein the system further comprises:
a plurality of personal security devices including the personal security device of the user, each of the plurality of personal security devices configured to:
receive from the security server the request to perform the security operation defined by the security operation script;
perform the security operation script; and
return to the security server a security operation result of performing the security operation script.

7. The system of claim 6, wherein each of the plurality of personal security devices is configured to:
obtain the security operation script defining the security operation requested by the security server.

8. The system of claim 1, wherein the security task is associated with transaction data, the security operation script is a micro application (μ-app) that provides instructions to the personal security device for processing the transaction data, and the μ-app does not include the transaction data.

9. A personal security device configured to:
receive from a security server a request to perform a security operation defined by a security operation script;
perform the security operation script; and
return to the security server a security operation result of performing the security operation script.

10. The personal security device of claim 9, wherein the personal security device is further configured to:
obtain the security operation script defining the security operation requested by the security server.

11. The personal security device of claim 10, wherein the request to perform the security operation defined by the security operation script comprises an identifier of the security operation script and the personal security device obtains the security operation script using the identifier of the security operation script.

12. The personal security device of claim 10, wherein the request to perform the security operation defined by the security operation script comprises the security operation script and the personal security device obtains the security operation script from the request to perform the security operation.

13. The personal security device of claim 9, wherein the security operation script is a micro application (μ-app) that provides instructions to the personal security device for processing transaction data associated with a security task and the μ-app does not include the transaction data.

14. A method for securing interaction of a user with a computer-based application, the method comprising steps of:
receiving, by a security server, from the computer-based application a request to perform a security task for the user;
identifying, a security operation script corresponding to the security task;
sending, by the security server, to a personal security device of the user a request to perform a security operation defined by the security operation script;
receiving, by the security server, a security operation result of performing the security operation script by the personal security device;
determining, by the security server, a security task result as a function of the security operation result; and
returning, by the security server, the security task result to the computer-based application.

15. The method of claim 14, further comprising the step of:
identifying, by the security server, from among a plurality of personal security devices the personal security device associated with the user;
wherein the request to perform the security operation defined by the security operation script is sent by the security server to the identified personal security device associated with the user.

16. The method of claim 14, wherein the method further comprising the steps of:
receiving, by the personal security device, the request to perform the security operation defined by the security operation script;
performing, by the personal security device, the security operation script; and returning, by the personal security device, to the security server a
security operation result of the performing by the personal security device of the security operation script.

17. The method of claim 14, the method further comprising the steps of:
obtaining, by the personal security device, the security operation script.

18. The method of claim 17, wherein the request to perform the security operation defined by the security operation script comprises an identifier of the security operation script and the personal security device obtains the security operation script using the identifier of the security operation script.

19. The method of claim 17, wherein the request to perform the security operation defined by the security operation script comprises the security operation script and the personal security device obtains the security operation script from the request to perform the security operation.

20. The method of claim 14, wherein the security task is associated with transaction data, the security operation script is a micro application (μ-app) that provides instructions to the personal security device for processing the transaction data, and the μ-app does not include the transaction data.
